(19) United States
(12) Patent Application Publication
(10) Pub. No.: US 2026/0056945 A1
(43) Pub. Date: Feb. 26, 2026

(54) SYSTEMS AND METHODS FOR INTERFACING WITH DATA WAREHOUSES TO PERFORM ANALYTICS

(71) Applicant: Hitachi, Ltd., Tokyo (JP)

(72) Inventors: Dipanjan GHOSH, Santa Clara, CA (US); Aman KUMAR, Santa Clara, CA (US); Ahmed FARAHAT, Santa Clara, CA (US); Chetan GUPTA, Santa Clara, CA (US)

(21) Appl. No.: 18/814,209

(22) Filed: Aug. 23, 2024

(51) Int. Cl. G06F 16/2452; G06F 16/248; G06F 16/28

(52) U.S. Cl. CPC G06F 16/24522; G06F 16/248; G06F 16/283

(57) ABSTRACT

Systems and methods may utilize a system configurator to populate an information template associated with a data warehouse (DWH) to generate standardized context information. A DWH query code generator, may use an embedding model to obtain an embedded user question, perform a first similarity matching process to match the embedded user question with a standard question template, extract parameters from the user question to populate the standard question template, populate the standard question template with the extracted parameters to generate a final question, and provide the final question and the standardized context information to a generative AI model that converts the final question into a query code. A visualization code generator may then obtain data related to the user question, perform a second similarity matching process to match the embedded user question with a visualization script, and apply the visualization script to the data to generate a visualization.

### BACKGROUND

### Field

The present disclosure is generally directed to data structures, and more specifically, to systems and methods for efficient interactions with data structures, such as technical data warehouses, to perform analytics to gain insight that enhances decision-making processes.

### Related Art

Organization data from various applications and processes reside within tables across various databases. Typically, such data are separated based on application and organizational security requirements, resulting in different databases for different business units. Achieving end-to-end analysis and gaining a holistic perspective from this data is of critical importance at various levels in the organization hierarchy for decision-making. However, this process is challenging due to the following reasons:

There is a significant lack of understanding of end-to-end databases and data among end-users, analysts, and decision-makers. The necessary knowledge is oftentimes limited to a small number of handful technical experts.

End-users typically depend on custom applications and reports but lack the technical skills and understanding to execute ad-hoc analytics. Only technical teams, who are not business users, can perform these analytics, which requires considerable development time.

End-users and domain experts understand the relationship between applications but not from the underlying database perspective. Further, the underlying tables may have non-intuitive field names that end-users are unfamiliar with. There exists a significant knowledge gap between the end-users, who have domain expertise, and technical teams, who have technical expertise but lack business knowledge.

While natural language-based database interaction exists, such concepts do not include the aspect of providing an interface for non-technical users who are focused mainly on gaining insights without possessing technical knowledge such as how fields in databases are partitioned. For example, methods like Chain-to-Table either require expert prompt engineers, who are also technical experts, or other methods that do not function effectively on tables with non-descriptive field names.

Although generic methods exist for interfacing generative AI with databases based on publicly available information, such as those depicted in FIG. 1, such methods do not address the specific technical problems outlined above.

Therefore, it is desirable to have systems and methods that directly communicate with end-users (e.g., executives, analysts, and other decision makers) in a non-technical manner using natural language queries on underlying data to extract and analyze information to deliver consistent results that can be visualized in a customized manner, based on user preference (e.g., bar chart, line chart, table). This allows non-technical users to gain actionable insights that aid their decision-making processes. As a result, business users need not rely on IT and applications teams to translate queries and technical requirements into information on dashboards, which may still require further analysis.

### SUMMARY

In some aspects of the disclosure, a method for interacting with and visualizing complex data warehouse (DWH) data using natural language user questions comprises: at a system configurator, populating a DWH information template with information related to a plurality of databases associated with a DWH, which may be non-standard databases and comprise a schema or a relationship between tables to generate standardized context information; at a DWH query code generator, performing steps including: in response to receiving a user question, e.g., in natural language format, using an embedding model to obtain an embedded user question; performing a first similarity matching process to match the embedded user question with a standard question template in a question template vector database; extracting parameters from the user question to populate the standard question template; populating the standard question template with the extracted parameters to generate a final question; and providing the final question and the standardized context information to a generative AI model, e.g., a transformer-based model that has been trained for SQL query generation, that converts the final question into a query code; and at a visualization code generator, performing steps including: in response to executing the query code, obtaining data related to the user question; performing a second similarity matching process to match the embedded user question with a visualization script, e.g., Python code, in a visualization template vector database; applying the visualization script to the data to generate a visualization; and outputting the visualization in a predefined format, such as a bar chart, a line chart, a pie chart, or a table. The output may be further refined, e.g., based on user feedback.

The embedding model may be a pre-trained embedding model that is configured to transform natural language into a vector representation. At least one of the first similarity matching process or the second similarity matching process comprises using a cosine similarity to find a closest standard question template in the question template vector database. Extracting parameters from the user question may comprise identifying a set of parameters.

In some aspects, the techniques described herein relate to a non-transitory computer-readable medium for storing instructions for executing the process.

In some aspects, the techniques described herein relate to a system for interacting with and visualizing complex DWH data using natural language user questions, the system comprising: a system configurator configured to populate a DWH information template with information related to a plurality of databases that are associated with a DWH to generate standardized context information; a DWH query code generator configured to perform steps comprising: in response to receiving a user question, using an embedding model to obtain an embedded user question; performing a first similarity matching process to match the embedded user question with a standard question template in a question template vector database; extracting parameters from the user question to populate the standard question template; populating the standard question template with the extracted parameters to generate a final question; and providing the final question and the standardized context information to a generative AI model that converts the final question into a query code; and a visualization code generator configured to perform steps comprising: in response to executing the query code, obtaining data related to the user question; performing a second similarity matching process to match the embedded user question with a visualization script in a visualization template vector database; applying the visualization script to the data to generate a visualization; and outputting the visualization in a predefined format.

Aspects of the present disclosure can involve a system, which can involve means for performing steps comprising: populating a DWH information template with information related to a plurality of databases associated with a DWH to generate standardized context information; means for performing steps comprising: in response to receiving a user question, using an embedding model to obtain an embedded user question; performing a first similarity matching process to match the embedded user question with a standard question template in a question template vector database; extracting parameters from the user question to populate the standard question template; populating the standard question template with the extracted parameters to generate a final question; and providing the final question and the standardized context information to a generative AI model that converts the final question into a query code; means for performing steps comprising: in response to executing the query code, obtaining data related to the user question; performing a second similarity matching process to match the embedded user question with a visualization script in a visualization template vector database; applying the visualization script to the data to generate a visualization; and outputting the visualization in a predefined format.

### BRIEF DESCRIPTION OF DRAWINGS

FIG. 1 depicts a generic method for interfacing generative AI with a database.

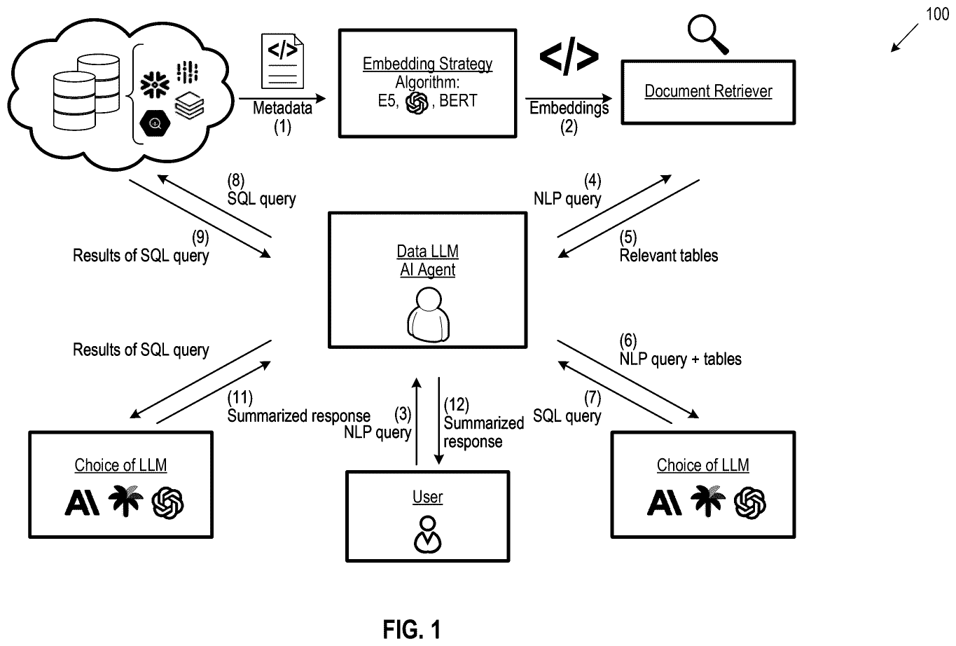

FIG. 2 illustrates exemplary components of a generative AI and data warehouse interface system, according to various embodiments of the present disclosure.

FIG. 3 depicts details of the system shown in FIG. 2, according to various embodiments of the present disclosure.

FIG. 4 is an exemplary flowchart illustrating a process for interacting with and visualizing complex DWH data using natural language user questions, in accordance with various embodiments of the present disclosure.

FIG. 5 illustrates an example computing environment with an example computer device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

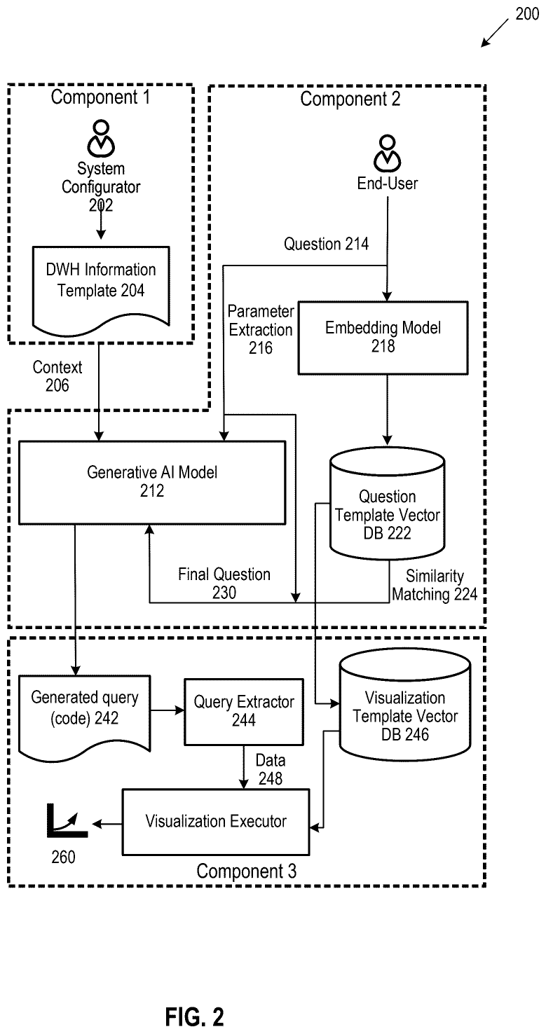

FIG. 2 illustrates exemplary components of a generative AI and data warehouse interface system, according to various embodiments of the present disclosure. As depicted system 200 comprises system configurator 202, DWH query code generator 210, and visualization code generator 240. System configurator 202, in turn, comprises DWH information template 204. DWH query code generator 210 comprises generative AI model 212, user question 214, embedding model 218, and question template vector database 222. Visualization code generator 240 comprises visualization template vector database 246, query executed 242, and visualization executor 250.

In embodiments, system configurator 202 may use information from any number of databases in a DHW (not shown in FIG. 2) to populate DWH information template 204, which standardizes information obtained from the databases. Information in each database may be associated with its own schemas; constraints associated with each schema, table, or field; special instructions; specific domain knowledge; list of tables, fields, or schema names; meaning or purpose for each schema; brief description of each field; unique values associated with each field; custom formulae or metrics to be applied to compute KPIs or analytics, and so on.

For example, DWH information template 204 may comprise, e.g., different schemas for each table that comprise configuration information or a meaning of the table in a particular context. Once generated and/or configured, e.g., in a natural language format, DWH template 204 is communicated to generative AI model 212.

In embodiments, to extract insights for user question 214, or perform analytics on the underlying data, user question 214 may be mapped to query code 242. While common generative AI models can generate query code, they lack the capacity to handle complex data warehouses or translate query code into effective and robust visualizations. To ensure robust code creation and effective visualization, robust and well-formulated questions as prompts are desirable. as discussed in greater detail below; to achieve this, embodiments herein embed template scripts and utilize vector databases.

To facilitate effective query code creation on complex DWH 204, DWH query code generator 210 utilizes context information 206 generated by system configurator 202. Although user question 214 may vary from user to user, in embodiments, question 214 is semantically mapped to a standard question template within question template vector database 221. DWH template 204 is converted to standardized context information 206 prior to being communicated to generative AI model 212.

In embodiments, system configurator 202 uses DWH template 204 to generate context information 206 that enables generative AI model 212 to translate user question 214 to code query 242 (e.g., SQL), e.g., based on user question 214. The generated context information 206 may be part of a prompt that DWH information template 204 sends to generative AI model 212.

To generate DWH query code 242 in a consistent and reliable manner, DWH query code generator 210 may apply user question 214 obtained from an end-user to any embedding model 218 known in the art to generate embedded user question 220. DWH query code generator 210 may accomplish this, for example, by using an existing standard question template embedding that has been stored in question template vector database 222, e.g., in the form of standard question embeddings that have been generated and parameterized by embedding model 218. This approach allows for effective semantic searching for the nearest standard question template for user question 214 in the embedding space. In embodiments, DWH query code generator 210 may perform similarity matching 224 between embedded user question 220 and an embedded and a parameterized standard user question obtained from question template vector database 222 to extract the most relevant standard question or related template script from vector database 222.

Additionally, DWH query code generator 210 may use generative AI model 212 to extract parameters 216 from user question 214 (e.g., name, country, date range, organization name, etc.). The extracted parameters 216 may be used to populate the extracted question template obtained from question template vector database 222 to create final question 230. Final question 230 is then communicated to generative AI model 212 as a prompt, along with DWH context 206 to generate query 242 within provided context information 206. In this manner, user question 214 can be mapped, e.g., into a SQL query, without leaking confidential transactional information.

In embodiments, visualization code generator 240 may execute query code 242, which has been generated by DWH query code generator 210 in the underlying DWH environment, to obtain data 248 associated with a response related to the user question. When executing query code 242 by using data query executor 244, e.g., in an offline mode, visualization code generator 240 may further apply a visualization script (e.g., a Python code) on data 248 to generate visualization 260. The resulting visualization 260 may then be communicated to a user in a default or custom format comprising tables, lists, graphs, or any combination thereof, e.g., based on user feedback. For example, a user may be presented with a visualization that comprises options for the user to customize visualization format or style.

Operating visualization code generator 240 by using standardized prompts based on user question 214 and/or predefined user-preferences, advantageously, allows visualizations to be produced in a consistent manner not achievable by existing generative AI models alone.

In embodiments, visualization code generator 240 may extract a suitable visualization script from an existing visualization template vector database 240, e.g., by using similarity matching 224 between embedded user question 220 and scripts in visualization template vector database 246. Advantageously, using embedding model 218 to generate embedded user question 220 enhances consistent visualization generation.

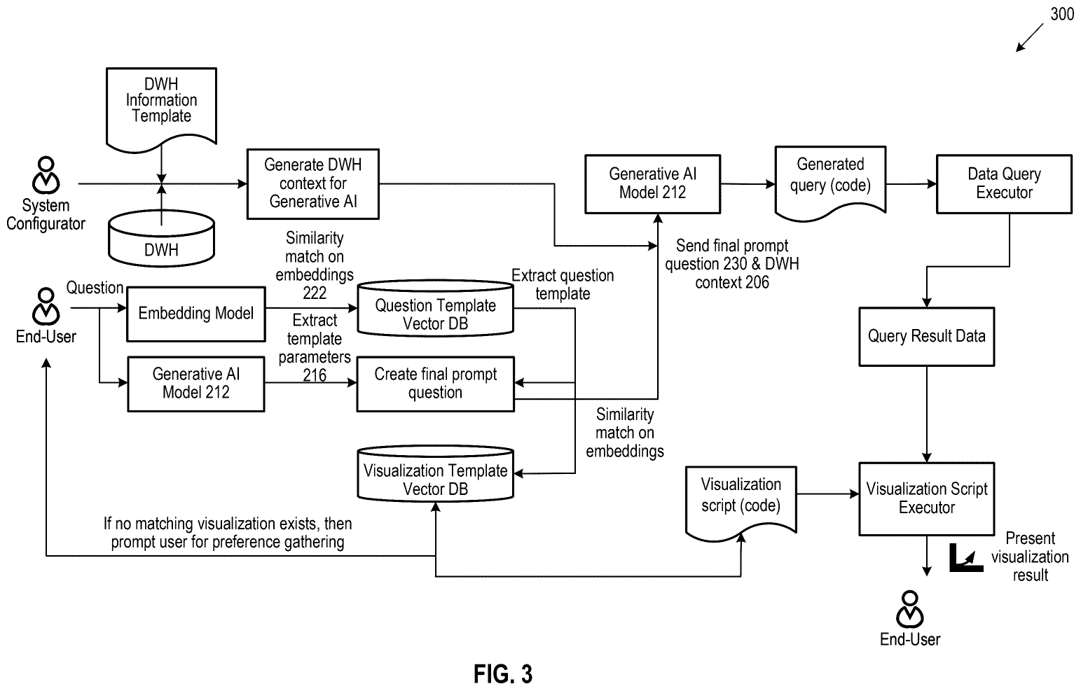

FIG. 3 depicts additional details of the system shown in FIG. 2, according to various embodiments of the present disclosure. For clarity, components similar to those shown in FIG. 2 are labeled in the same manner. For purposes of brevity, a description of their function is not repeated here.

System 300 provides generic and standardized methods to interface natural language queries with complex DWHs. The system can interact with complex DWH schemas as well as non-standard databases and DWHs to provide flexible and robust solutions for data analysis.

Advantageously, system 300 may generate end-to-end insights, such as linking customer relationship data to sales data, using the natural language question by executing analytics formulae and interfacing with underlying DWH. Further, system 300 may provide generic, standardized, and preference-based visualization generation on resulting queries. The outputs are robust for data query generation and visualization for natural language questions.

System 300 enables natural language interactions, allowing end-users to query DWHs directly to gain insights and perform analytics. By utilizing generative AI, system 300 translates natural language questions into precise query codes, generating visual representations and actionable insights that aid in the decision-making process. This bridges the gap between technical complexity and user-accessibility, thus enabling non-technical users to effectively interact with complex data structures.

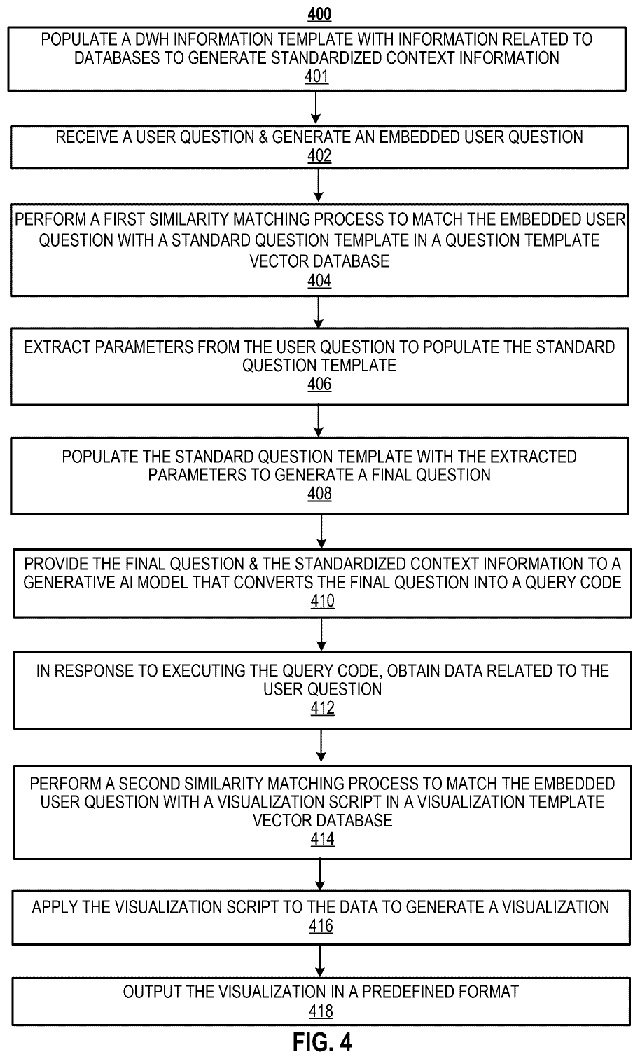

FIG. 4 is a flowchart illustrating an exemplary process for interacting with and visualizing complex DWH data using natural language user questions, in accordance with various embodiments of the present disclosure. In embodiments, process 400 may start at step 401, when a system configurator populates a DWH information template with information related to a plurality of databases associated with a DWH to generate standardized context information. The databases, which may be non-standard databases, may comprise a schema or a relationship between tables.

At step 402, a DWH query code generator receives a user question and uses an embedding model, e.g., a pre-trained embedding model that is configured to transform natural language into a vector representation, to obtain an embedded user question.

At step 404, the DWH query code generator may perform a first similarity matching process to match the embedded user question with a standard question template in a question template vector database.

At step 406, the DWH query code generator may extract parameters from the user question to populate the standard question template.

At step 408, the DWH query code generator may provide the final question and the standardized context information to a generative AI model, e.g., transformer-based model trained for SQL query generation that converts the final question into a query code.

At step 408, a visualization code generator may, in response to executing the query code, obtain data related to the user question.

At step 410, the visualization code generator may perform a second similarity matching process to match the embedded user question with a visualization script, e.g., Python code, in a visualization template vector database. The first similarity or second similarity matching process may comprise using a cosine similarity to find a closest standard question template in the question template vector database.

At step 412, the visualization code generator may apply the visualization script to the data to generate a visualization.

At step 414, the visualization may be output, e.g., in a predefined format, such as a bar chart, a line chart, a pie chart, or a table, and refined based on user feedback.

One skilled in the art shall recognize that: (1) certain steps may optionally be performed; (2) steps may not be limited to the specific order set forth herein; (3) certain steps may be performed in different orders; and (4) certain steps may be done concurrently.

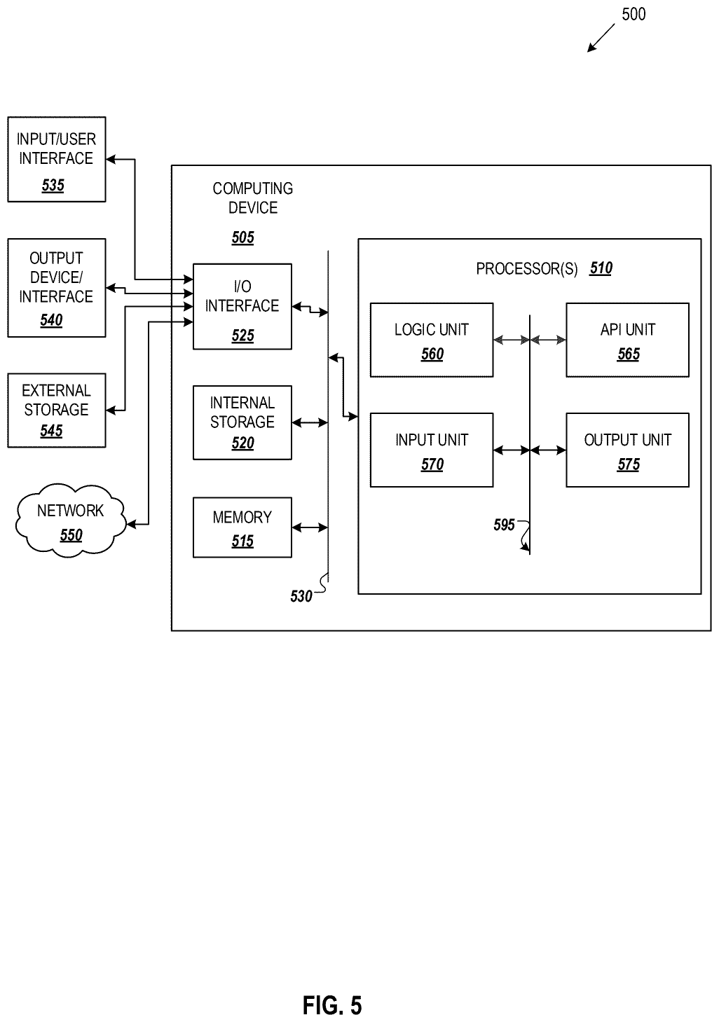

FIG. 5 illustrates an example computing environment with an example computer device suitable for use in some example implementations. Computer device 505 in computing environment 500 can include one or more processing units, cores, or processors 510, memory 515 (e.g., RAM, ROM, and/or the like), internal storage 520 (e.g., magnetic, optical, solid-state storage, and/or organic), and/or I/O interface 525, any of which can be coupled on a communication mechanism or bus 530 for communicating information or embedded in the computer device 505. I/O interface 525 is also configured to receive images from cameras or provide images to projectors or displays, depending on the desired implementation.

Computer device 505 can be communicatively coupled to input/user interface 535 and output device/interface 540. Either one or both of input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 540 may include a display, television, monitor, printer, speaker, braille, or the like. In some example implementations, input/user interface 535 and output device/interface 540 can be embedded with or physically coupled to the computer device 505. In other example implementations, other computer devices may function as or provide the functions of input/user interface 535 and output device/interface 540 for a computer device 505.

Examples of computer device 505 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via I/O interface 525) to external storage 545 and network 550 for communicating with any number of networked components, devices, and systems, including one or more computer devices of the same or different configurations. Computer device 505 or any connected computer device can be functioning as, providing services of, or referred to as a server, client, thin server, general machine, special-purpose machine, or another label.

I/O interface 525 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, a satellite network, and the like).

Computer device 505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or implementation and are not limited to the descriptions provided. Processor(s) 510 can be in the form of hardware processors such as central processing units (CPUs) or a combination of hardware and software units.

In some example implementations, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, input unit 570, and output unit 575, in some example implementations described above. For example, the flow of one or more processes or implementations may be controlled by logic unit 560 alone or in conjunction with API unit 565. The input unit 570 may be configured to obtain input for the calculations described in the example implementations, and the output unit 575 may be configured to provide output based on the calculations described in example implementations.

Processor(s) 510 can be configured to execute a method or computer instructions which can involve populating a DWH information template with information related to a plurality of databases associated with a DWH to generate standardized context information, as described with respect to FIG. 2-FIG. 5.

Processor(s) 510 can be further configured to execute a method or computer instructions which can involve, in response to receiving a user question, using an embedding model to obtain an embedded user question; performing a first similarity matching process to match the embedded user question with a standard question template in a question template vector database; extracting parameters from the user question to populate the standard question template; populating the standard question template with the extracted parameters to generate a final question; and providing the final question and the standardized context information to a generative AI model that converts the final question into a query code, as described, for example, with respect to FIG. 2. Processor(s) 510 can be further configured to execute a method or computer instructions which can involve, in response to executing the query code, obtaining data related to the user question; performing a second similarity matching process to match the embedded user question with a visualization script in a visualization template vector database; applying the visualization script to the data to generate a visualization; and outputting the visualization in a predefined format, as described, for example, with respect to FIG. 2 and FIG. 3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for interacting with and visualizing complex data warehouse (DWH) data using natural language user questions, the method comprising:
at a system configurator, populating a DWH information template with information related to a plurality of databases associated with a DWH to generate standardized context information;
at a DWH query code generator, performing steps comprising:
in response to receiving a user question, using an embedding model to obtain an embedded user question;
performing a first similarity matching process to match the embedded user question with a standard question template in a question template vector database;
extracting parameters from the user question to populate the standard question template;
populating the standard question template with the extracted parameters to generate a final question; and
providing the final question and the standardized context information to a generative AI model that converts the final question into a query code; and
at a visualization code generator, performing steps comprising:
in response to executing the query code, obtaining data related to the user question;
performing a second similarity matching process to match the embedded user question with a visualization script in a visualization template vector database;
applying the visualization script to the data to generate a visualization; and
outputting the visualization in a predefined format.

2. The method of claim 1, wherein the embedding model is a pre-trained embedding model that is configured to transform natural language into a vector representation.

3. The method of claim 1, wherein at least one of the first similarity matching process or the second similarity matching process comprises using a cosine similarity to find a closest standard question template in the question template vector database.

4. The method of claim 1, wherein the extracting parameters from the user question comprises identifying a set of parameters.

5. The method of claim 1, wherein the generative AI model is a transformer-based model that has been trained for SQL query generation.

6. The method of claim 1, wherein the predefined format comprises at least one of a bar chart, a line chart, a pie chart, or a table.

7. The method of claim 1, further comprising based on user feedback on the generated visualization refining the visualization.

8. The method of claim 1, wherein the predefined format comprises customization options for the visualization.

9. The method of claim 1, wherein the information related to the plurality of databases comprises at least one of a schema or a relationship between tables, and wherein at least one of the plurality of databases is a non-standard database.

10. The method of claim 1, wherein the user question comprises a natural language format, and wherein the visualization script comprises Python code.

11. A non-transitory computer-readable medium for storing instructions for executing a process, the instructions comprising:
populating a DWH information template with information related to a plurality of databases associated with a DWH to generate standardized context information;
in response to receiving a user question, using an embedding model to obtain an embedded user question;
performing a first similarity matching process to match the embedded user question with a standard question template in a question template vector database;
extracting parameters from the user question to populate the standard question template;
populating the standard question template with the extracted parameters to generate a final question;
providing the final question and the standardized context information to a generative AI model that converts the final question into a query code;
in response to executing the query code, obtaining data related to the user question;
performing a second similarity matching process to match the embedded user question with a visualization script in a visualization template vector database;
applying the visualization script to the data to generate a visualization; and
outputting the visualization in a predefined format.

12. The non-transitory computer-readable medium of claim 11, wherein embedding model is a pre-trained embedding model that is configured to transform natural language into a vector representation.

13. The non-transitory computer-readable medium of claim 11, wherein at least one of the first similarity matching process or the second similarity matching process comprises using a cosine similarity to find a closest standard question template in the question template vector database.

14. The non-transitory computer-readable medium of claim 11, wherein the extracting parameters from the user question comprises identifying a set of parameters.

15. The non-transitory computer-readable medium of claim 11, wherein the generative AI model is a transformer-based model that has been trained for SQL query generation.

16. The method of claim 1, wherein the predefined format comprises at least one of a bar chart, a line chart, a pie chart, or a table.

17. The non-transitory computer-readable medium of claim 11, wherein presenting the visualization to the user comprises options for the user to customize a visualization format.

18. The non-transitory computer-readable medium of claim 11, wherein the information related to the plurality of databases comprises at least one of a schema or a relationship between tables, and wherein at least one of the plurality of databases is a non-standard database.

19. The non-transitory computer-readable medium of claim 11, wherein the user question comprises a natural language format, and wherein the visualization script comprises Python code.

20. A system for interacting with and visualizing complex data warehouse (DWH) data using natural language user questions, the system comprising:
a system configurator configured to populate a DWH information template with information related to a plurality of databases that are associated with a DWH to generate standardized context information;
a DWH query code generator configured to perform steps comprising:
in response to receiving a user question, using an embedding model to obtain an embedded user question;
performing a first similarity matching process to match the embedded user question with a standard question template in a question template vector database;
extracting parameters from the user question to populate the standard question template;
populating the standard question template with the extracted parameters to generate a final question; and
providing the final question and the standardized context information to a generative AI model that converts the final question into a query code; and
a visualization code generator configured to perform steps comprising:
in response to executing the query code, obtaining data related to the user question;
performing a second similarity matching process to match the embedded user question with a visualization script in a visualization template vector database;
applying the visualization script to the data to generate a visualization; and
outputting the visualization in a predefined format.
